(19) United States
(12) Patent Application Publication
(10) Pub. No.: US 2026/0296972 A1
(43) Pub. Date: Oct. 1, 2026

(54) STRAIN TOLERANT RECYCLED ASPHALT PAVEMENT COMPOSITION

(71) Applicant: ArrMaz Products Inc., Mulberry, FL (US)

(72) Inventors: Michael William Longshaw, Towanda, KS (US); Corey Dean Christian, Broken Arrow, OK (US)

(73) Assignee: ArrMaz Products Inc., Mulberry, FL (US)

(21) Appl. No.: 19/688,632

(22) Filed: May 27, 2026

Related U.S. Application Data
(63) Continuation of application No. 17/348,393, filed on Jun. 15, 2021, now abandoned.
(60) Provisional application No. 63/040,306, filed on Jun. 17, 2020.

(51) Int. Cl. C04B 26/26; C04B 16/04; C04B 18/02; C08L 25/10; C08L 95/00

(52) U.S. Cl. CPC C04B 26/26; C04B 16/04; C04B 18/02; C08L 25/10; C08L 95/00

(57) ABSTRACT

A strain tolerant recycled bitumen pavement composition comprising aggregate, recycled bitumen, and a specialized polymer modified bitumen. The specialized polymer modified bitumen may comprise bitumen and polymer, where the polymer comprises a preponderance of butadiene. The amount of recycled bitumen in the composition may be greater than 5% of the composition. Such high levels of recycled bitumen in a pavement composition, while desirable both economically and environmentally, typically produces layers with poor strain tolerance. The strain tolerance of the layer produced with the composition of the present invention, however, may be significantly higher due to the inclusion of the specialized polymer modified bitumen.

### CROSS REFERENCE

This application is a continuation of U.S. patent application Ser. No. 17/348,393, filed Jun. 15, 2021, which is based on and claims priority to U.S. Provisional Application No. 63/040,306 filed Jun. 17, 2020.

### BACKGROUND OF THE INVENTION

### Field of the Invention

This invention relates generally to pavement compositions, and more particularly, but not by way of limitation, to a strain tolerant recycled bitumen pavement composition.

### Description of the Related Art

It is desirable to place a new surface or a new pavement over pavement used to construct roads, parking lots, airport runways, airport taxiways, and the like and not have cracks appear in the new pavement for long periods of time. Cracks in the existing pavement frequently propagate or reflect through a new surface. Cracks in the pavement are a form of distress, which can lead to premature failure of the new pavement. The cracks allow moisture (i.e. water) to enter into the existing (i.e. underlying) pavement and create structural support issues. Cracks also require additional intensive maintenance like crack sealing to maintain longevity of the paved layer and reduce raveling of the cracks. Additionally, the cracks can also create ride quality issues, which may require grinding to smoothing, or significant costs to apply one or more additional pavement layers to address the problem.

Bituminous roads are generally produced with a preponderance of aggregate of a multitude of sizes with an asphalt or bituminous material. At a processing or hot mix plant, aggregate is heated and the bitumen is added and mixed. The resulting mixture is taken to a road to be paved and applied as a paved surface.

When a paved surface meets or exceeds its service life, it may be recycled. The layer may be ground up with a milling machine to make recycled asphalt pavement (RAP).

RAP typically contains high quality aggregate and oxidized or aged bitumen. It is routinely saved for future paving.

Economically, it is advantageous to reuse RAP in paved surfaces. The cost of RAP to the owner is quite low. The cost of new aggregate is relatively high. Additionally, the oxidized or aged bitumen has considerable value too which is a source of recycled bitumen.

Environmentally, it is advantageous to utilize RAP in new pavement structures. As mineral deposits deplete, it is highly preferable to reuse or recycle aggregate. Also, reuse of the oxidized or aged bitumen minimizes reliance of non-renewable resources. The impact on greenhouse gasses and the like is significant, yielding favorable environmental consequences. RAP is the most recycled product in the world.

Another source of recycled bitumen is recycling asphalt shingles (RAS). Roofing shingles contain valuable bitumen originating from either initial shingle production waste or old and aged shingles from roof installations.

Both RAP and RAS may be considered as sources of recycled bitumen.

In the design and development of mixtures for paved layers with recycled bitumen, the total bitumen content is a critical component for engineering considerations. The total bitumen content refers to all bitumen sources like virgin bitumen, the bitumen component of RAP, the bitumen component of RAS, and the like.

For example, for a mixture of aggregate, 30% RAP containing 4.2% aged bitumen, and 3.40% virgin bitumen, the total bitumen content would be the sum of the two bitumen sources. Thus 30% RAP at 4.2% aged bitumen would yield 1.26% recycled bitumen plus 3.40% virgin bitumen yields a Total Bitumen Content of 4.66% bitumen.

Similarly, the percent recycled bitumen would be a calculation of 1.26% recycled bitumen from the RAP divided by 4.66% total bitumen content which yields 27.0% recycled bitumen.

Unfortunately, recycled bitumen may not perform as well as virgin bitumen. The oxidization or aging process renders the bitumen hard and brittle. This is the prevailing reason the paved layer cracks over time. A suitable paved layer will tolerate strains from traffic and environmental strains with little to no cracking. Tolerance to traffic and environmental strains diminish as bitumen oxidizes. To that end, a point comes over time when the paved layer cannot tolerate strain due to traffic or environmental conditions and cracks.

It is a common practice to use small amounts of recycled bitumen in new paving mixtures. Virgin bitumen as well as additional aggregates are combined with recycled bitumen to produce a new paving mixture.

To account for the harder, oxidized or aged bitumen when recycled bitumen is employed in new pavements, some practitioners utilize a softer than normal virgin bitumen to counter the harder oxidized or aged bitumen in the recycled bitumen.

Although environmental and economic considerations greatly favor an unlimited use of recycled bitumen in new pavements, performance of the paved layer quickly diminishes. Strain tolerance is lost and the new paved layer may crack prematurely.

Accordingly, there remains a need for a composition and method to efficiently create a new paved layer utilizing environmental and economic quantities of recycled bitumen while maintaining strain tolerance for delaying the onset of cracking.

### SUMMARY OF THE INVENTION

In general, in a first aspect, the invention relates to a composition comprising aggregate, recycled bitumen, and a specialized polymer modified bitumen. The specialized polymer modified bitumen may comprise bitumen and polymer, where the polymer comprises a preponderance of butadiene.

The recycled bituminous pavement may be greater than 5% of the total bitumen content, preferably greater than 25% of the total bitumen content, more preferably greater than preferably greater than 30% of the total bitumen content, even more preferably greater than 35% of the total bitumen content, or most preferably greater than 40% of the total bitumen content.

The polymer may be greater than 3% of the specialized polymer modified bitumen, preferably greater than 4% of the specialized polymer modified bitumen, and more preferably greater than 5% of the specialized polymer modified bitumen. The polymer may be styrene-butadiene polymer. The butadiene content may be greater than 1.5% of the specialized polymer modified bitumen, preferably greater than 2.0% of the specialized polymer modified bitumen, and more preferably greater than 2.5% of the specialized polymer modified bitumen.

The specialized polymer modified bitumen may further comprise cross-linking agent, vulcanization agents, accelerators, extenders, fluxing agents, rejuvenating agents, polyphosphoric acid, or a combination thereof.

In a second aspect, the invention relates to a method for creating a strain tolerant layer, the method comprising mixing aggregate, recycled bitumen, and a specialized polymer modified bitumen to produce a bituminous pavement composition, where the specialized polymer modified bitumen comprises bitumen and specialized polymer, where the polymer comprises a preponderance of butadiene, and using the bituminous pavement composition to produce the strain tolerant layer, where the strain tolerant layer has a strain tolerance of greater than 10,000 cycles to failure at 1000 microstrain, 15 C, and 10 Hz. Alternately, the strain tolerance may be greater than 20,000 cycles to failure or greater than 30,000 cycles to failure.

The recycled bituminous pavement may be greater than 5% of the total bitumen content, preferably greater than 25% of the total bitumen content, more preferably greater than preferably greater than 30% of the total bitumen content, even more preferably greater than 35% of the total bitumen content, or most preferably greater than 40% of the total bitumen content.

The polymer may be greater than 3% of the specialized polymer modified bitumen, preferably greater than 4% of the specialized polymer modified bitumen, and more preferably greater than 5% of the specialized polymer modified bitumen. The polymer may be styrene-butadiene polymer. The butadiene content may be greater than 1.5% of the specialized polymer modified bitumen, preferably greater than 2.0% of the specialized polymer modified bitumen, and more preferably greater than 2.5% of the specialized polymer modified bitumen.

The specialized polymer modified bitumen may further comprise cross-linking agent, vulcanization agents, accelerators, extenders, fluxing agents, rejuvenating agents, polyphosphoric acid, or a combination thereof.

### DETAILED DESCRIPTION OF THE INVENTION

The devices and methods discussed herein are merely illustrative of specific manners in which to make and use this invention and are not to be interpreted as limiting in scope.

While the devices and methods have been described with a certain degree of particularity, it is to be noted that many modifications may be made in the details of the construction and the arrangement of the devices and components without departing from the spirit and scope of this disclosure. It is understood that the devices and methods are not limited to the embodiments set forth herein for purposes of exemplification.

In general, in a first aspect, the invention relates to a strain tolerant recycled bituminous pavement composition comprising aggregate, recycled bitumen, and a specialized polymer modified bitumen. The composition may be used to produce a paved layer suitable for any pavement. The resulting paved layer may have a high strain tolerance as tested by AASHTO T321 Standard Method of Test for Determining the Fatigue Life of Compacted Asphalt Mixtures Subjected to Repeated Flexural Bending, where failure may be defined at the point where the load on the sample is approximately at 50% of the initial load as recorded in cycles at 10 Hz. For example, a paved layer produced from the composition may have a strain tolerance of greater than 10,000 cycles to failure, preferably greater than 20,000 cycles to failure, or more preferably greater than 30,000 cycles to failure when tested at 1000 microstrain.

The amount of recycled bitumen in the composition may be greater than 5% of the total bitumen content, preferably greater than 25% of the total bitumen content, more preferably greater than 30% of the total bitumen content, even more preferably greater than 35% of the total bitumen content, or most preferably greater than 40% of the total bitumen content. Such high levels of RAP in standard practice, while desirable both economically and environmentally, typically produce the poor strain tolerance discussed above, but the strain tolerance of the layer produced with the composition of the present invention may be significantly higher due to the inclusion of the specialized polymer modified bitumen.

The specialized polymer modified bitumen may be comprised of a sufficient amount of polymer to establish adequate fatigue cycles to failure. Suitable polymers may include those described in U.S. Pat. No. 4,154,710 issued to Maldonado et al. on May 15, 1979, U.S. Pat. No. 4,145,322 issued to Maldonado et al. on May 20, 1979, and/or U.S. Pat. No. 4,330,449 issued to Maldonado et al. on May 19, 1982, the entirety of all three of which are hereby incorporated herein by reference. For example, the polymer may be styrene-butadiene polymers. The quantity of polymer in the specialized polymer modified bitumen may be greater than 3.5% of the specialized polymer modified bitumen, preferably greater than 4% of the specialized polymer modified bitumen, and more preferably greater than 5% of the specialized polymer modified bitumen.

The structure of the polymer may contain a preponderance of butadiene, whereby the total butadiene content in the specialized polymer modified bitumen may be greater than 1.5%, preferably greater than 2.0%, and more preferably greater than 2.5%.

For example, a SBS block co-polymer containing 70% butadiene content when formulated in a polymer modified binder at 3.0% contains 2.1% total butadiene content.

Surprisingly, block copolymers having at least one block of monovinylaromatic as described by Klutzz in U.S. Pat. No. 7,728,074, incorporated herein by reference, and Stephens in U.S. Pat. No. 7,622,519, also incorporated herein by reference, may be ineffective in increasing strain tolerance in high RAP mixtures. Thus, the specialized polymer modified bitumen may not contain more than 3.0% polymer, preferably less than 2.0%, and more preferably less than 1% of polymer content from block copolymers containing monovinylaromatic structures.

The specialized polymer modified bitumen may contain asphalt or bitumen, as well as other additives suitable for use, such as cross-linking agents, vulcanization agents, accelerators, extenders, fluxing agents, polyphosphoric acid, and the like.

The specialized polymer modified bitumen may have a creep stiffness at normal testing temperatures for the prevailing grade of bitumen in the area of less than about 250 MPa, preferably less than 200 MPa, and more preferably less than 150 MPa, defined by AASHTO T 313: Determining the Flexural Creep Stiffness of Asphalt Binder Using the Bending Beam Rheometer (BBR), incorporated herein by reference.

### EXAMPLES

Testing was conducted for an area that is defined by a PG binder grade of PG64-22 by the LTPPBind software, which can be found on the FHWA website at https://infopave.fhwa.dot.gov/Tools/LTPPBindOnline as a LTPP InfoTooltm. The low testing criteria is −22 C and the Bending Beam Test temperature as an object of this invention is −12 C. Hence, the Creep Stiffness as tested at −12 C would be of less than about 250 MPa, preferably less than 200 MPa, and more preferably less than 150 MPa.

Bituminous binders in the US are generally specified by AASHTO M320, which is incorporated herein by reference. This specification defines a variety of binder grades based on climate.

A 60/70 pen bitumen, which is similar to a PG64-22 bitumen, using a crushed limestone aggregate and no RAP as tested by AASHTO T321 at 1000 microstrain yielded a result of 39,600 cycles to failure. This is considered a very good result for a normal paved layer without recycled bitumen.

A mixture containing aggregate, 40% RAP, 2.0% virgin bitumen yielding 37.0% recycled bitumen and reducing a normal PG grade for the climatic area from a PG64-22 to a softer PG58-28 yielded an inferior 6,895 cycles to failure. This data suggests the strain tolerance, or the ability to resist deformation from traffic, was significantly reduced.

The same mixture with the specialized polymer modified bitumen of the present invention was produced from a PG58-28, modified with greater than 5% polymer. The polymer contained a preponderance of butadiene, whereby the overall butadiene content was greater than 2.5% and creep stiffness, when tested at −12 C, was less than 150 MPa. This composition contained 35.1% recycled bitumen and yielded a cycles to failure of 67,130.

| | | % | Total | % | Cycles to |
|---|---|---|---|---|---|
| | % Virgin | Bitumen | Bitumen | Recycled | Failure |
| | Bitumen | from RAP | Content | Bitumen | 1000 μs |
| 60/70 pen graded | 4.80% | 0.00% | 4.80% | 0.00% | 39,600 |
| bitumen* | | | | | |
| Reduced bitumen | 3.40% | 2.00% | 5.40% | 37.00% | 6,895 |
| grade | | | | | |
| High PMA | 3.70% | 2.00% | 5.70% | 35.10% | 37,130 |
| Bitumen | | | | | |

*Kiavan, et al., Construction and Building Materials, 47, 2013.

From the above description, it is clear that the present invention is well adapted to carry out the objects and to attain the advantages mentioned herein as well as those inherent in the invention. While presently preferred embodiments of the invention have been described for purposes of this disclosure, it will be understood that numerous changes may be made which will readily suggest themselves to those skilled in the art and which are accomplished within the spirit of the invention disclosed and claimed.

What is claimed is:

1. A composition comprising:
aggregate;
recycled bitumen; and
a specialized polymer modified bitumen, where the specialized polymer modified bitumen comprises:
bitumen; and
specialized polymer, where the polymer comprises a preponderance of butadiene.

2. The composition of claim 1 where the recycled bitumen is greater than 35% of the total bitumen content.

3. The composition of claim 1 where the recycled bitumen is greater than 30% of the total bitumen content.

4. The composition of claim 1 where the recycled bitumen is greater than 25% of the total bitumen content.

5. The composition of claim 1 where the recycled bitumen is greater than 5% of the total bitumen content.

6. The composition of claim 1 where the specialized polymer is greater than 3% of the specialized polymer modified bitumen.

7. The composition of claim 1 where the specialized polymer is greater than 4% of the specialized polymer modified bitumen.

8. The composition of claim 1 where the specialized polymer is greater than 5% of the specialized polymer modified bitumen.

9. The composition of claim 1 where the polymer is styrene-butadiene polymer.

10. The composition of claim 1 where the butadiene is greater than 1.5% of the polymer modified bitumen.

11. The composition of claim 1 where the butadiene is greater than 2.0% of the polymer modified bitumen.

12. The composition of claim 1 where the butadiene is greater than 2.5% of the polymer modified bitumen.

13. The composition of claim 1 where the polymer contains no more than 3% butadiene with vinyl attachments.

14. The composition of claim 1 where the polymer contains no more than 1% butadiene with vinyl attachments.

15. The composition of claim 1 where the polymer contains no more than 2% butadiene with vinyl attachments.

16. The composition of claim 1 where the polymer contains no more than 3% butadiene with vinyl attachments.

17. The composition of claim 1 where the specialized polymer modified bitumen further comprises cross-linking agent, vulcanization agents, accelerators, extenders, fluxing agents, polyphosphoric acid, or a combination thereof.

18. A method for creating a strain tolerant layer, the method comprising:
mixing aggregate, recycled bitumen, and a specialized polymer modified bitumen to produce a bituminous pavement composition, where the specialized polymer modified bitumen comprises:
bitumen; and
specialized polymer, where the polymer comprises a preponderance of butadiene; and
using the bituminous pavement composition to produce the strain tolerant layer, where the strain tolerant layer has a strain tolerance of greater than 10,000 cycles to failure at 1000 microstrain, 15 C, and 10 Hz.

19. The method of claim 18 where the strain tolerance is greater than 20,000 cycles to failure at 1000 microstrain, 15 C, and 10 Hz.

20. The method of claim 18 where the strain tolerance is greater than 30,000 cycles to failure at 1000 microstrain, 15 C, and 10 Hz.

21. The method of claim 18 where the recycled bitumen is greater than 35% of the total bitumen content.

22. The method of claim 18 where the recycled bitumen is greater than 30% of the total bitumen content.

23. The method of claim 18 where the recycled bitumen is greater than 25% of the total bitumen content.

24. The method of claim 18 where the recycled bitumen is greater than 5% of the total bitumen content.

25. The method of claim 18 where the specialized polymer is greater than 3% of the specialized polymer modified bitumen.

26. The method of claim 18 where the specialized polymer is greater than 4% of the specialized polymer modified bitumen.

27. The method of claim 18 where the specialized polymer is greater than 5% of the specialized polymer modified bitumen.

28. The method of claim 18 where the polymer is styrene-butadiene polymer.

29. The method of claim 18 where the butadiene is greater than 1.5% of the polymer modified bitumen.

30. The method of claim 18 where the butadiene is greater than 2.0% of the polymer modified bitumen.

31. The method of claim 18 where the butadiene is greater than 2.5% of the polymer modified bitumen.

32. The method of claim 18 where the polymer contains no more than 3% butadiene with vinyl attachments.

33. The method of claim 18 where the polymer contains no more than 1% butadiene with vinyl attachments.

34. The method of claim 18 where the polymer contains no more than 2% butadiene with vinyl attachments.

35. The method of claim 18 where the polymer contains no more than 3% butadiene with vinyl attachments.

36. The method of claim 18 where the specialized polymer modified bitumen further comprises cross-linking agent, vulcanization agents, accelerators, extenders, fluxing agents, polyphosphoric acid, or a combination thereof.
